(19) United States
(12) Patent Application Publication
(10) Pub. No.: US 2015/0064969 A1
(43) Pub. Date: Mar. 5, 2015

(54) ELECTRICAL CONNECTOR ASSEMBLY

(71) Applicants: HON HAI PRECISION INDUSTRY CO., LTD., New Taipei (TW); HONG FU JIN PRECISION INDUSTRY(ShenZhen) Co., LTD., Shenzhen (CN)

(72) Inventors: YI-HSIANG KAO, New Taipei (TW); ZHI-GANG LIU, Shenzhen (CN)

(73) Assignees: HONG FU JIN PRECISION INDUSTRY(ShenZhen) Co., LTD., Shenzhen (CN); HON HAI PRECISION INDUSTRY CO., LTD., New Taipei (TW)

(21) Appl. No.: 14/062,594

(22) Filed: Oct. 24, 2013

(30) Foreign Application Priority Data
Aug. 27, 2013 (CN) 2013103776170

(51) Int. Cl. H01R 13/6596

(52) U.S. Cl. CPC H01R 13/6596
USPC 439/607.28

(57) ABSTRACT

An electrical connector assembly mounted to a metallic casing of an electronic device includes an insulating body, a metallic shell secured to the insulating body, and at least one conducting member secured to the metallic shell. When the electrical connector assembly is mounted to the casing of the electronic device, the conducting member elastically resists against the casing of the electronic device to maintain reliable contact between the electrical connector assembly and the casing of the electronic device.

### BACKGROUND

1. Technical Field

The present disclosure relates to an electrical connector assembly, and more particularly to an electrical connector assembly having an improved metallic shell.

2. Description of Related Art

HDMI connectors include a fixing assembly for mounting the HDMI connector. The HDMI connector is mounted to a shell of an electronic device and grounded. Because of a high cost of metal fixing assemblies, plastic fixing assemblies are often used. However, because the plastic fixing assemblies are insulating, the HDMI connector may be poorly ground and may be affected by electromagnetic pulses (EMIs).

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the three views.

FIG. 1 is a perspective view of an electrical connector assembly in accordance with a first embodiment.

FIG. 2 is an exploded view of the electrical connector assembly of FIG. 1, wherein the electrical connector assembly includes an insulating body.

FIG. 3 is a perspective view of the insulating body of FIG. 2.

FIG. 4 shows the electrical connector assembly of FIG. 1 being mounted to a housing of an electronic device.

FIG. 5 is an exploded view of an electrical connector assembly in accordance with a second embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

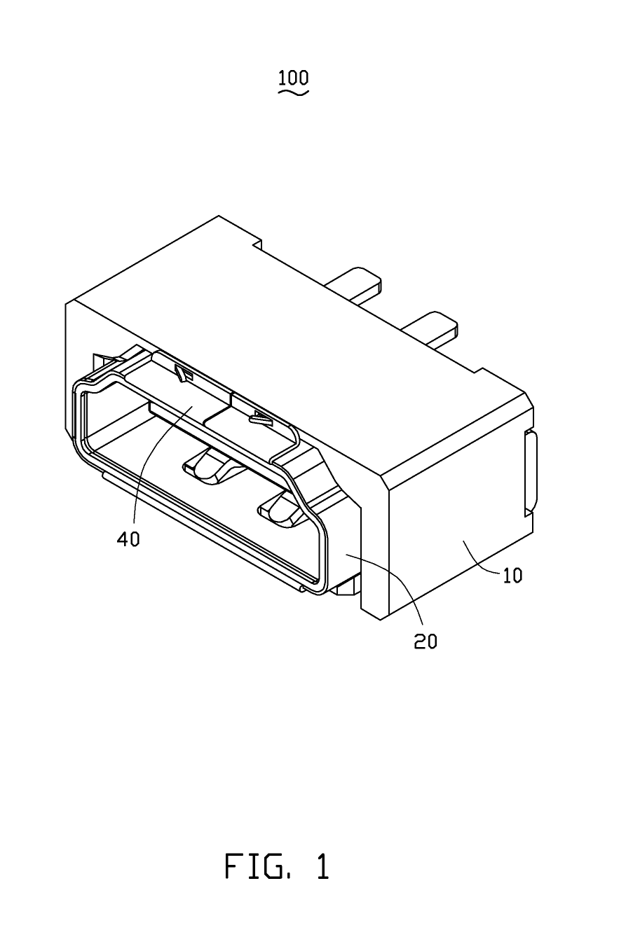

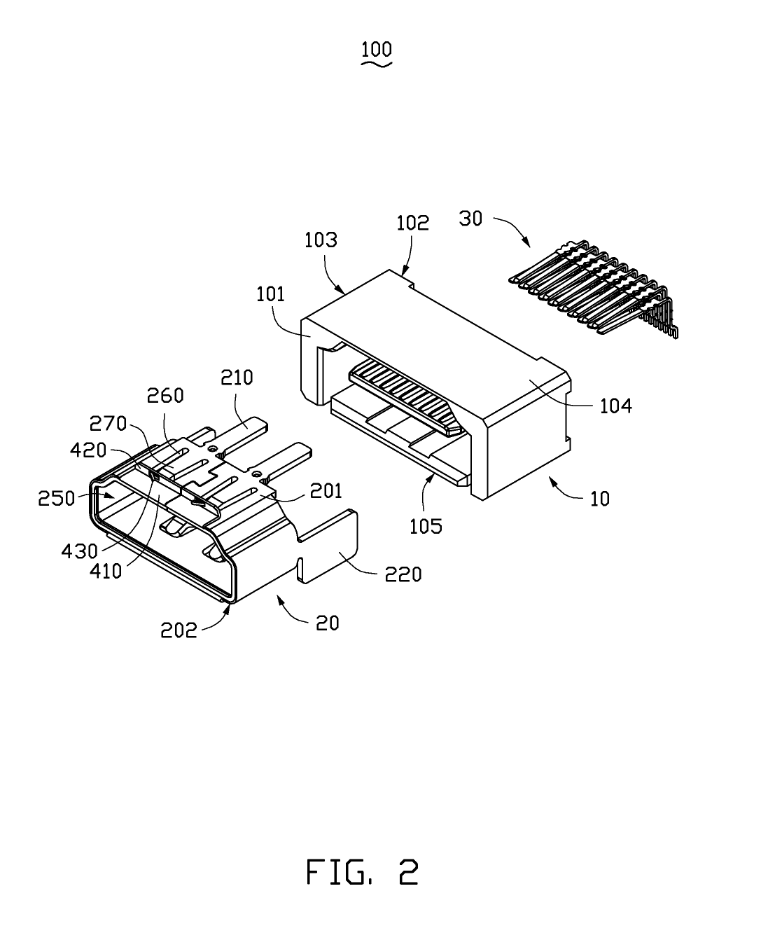

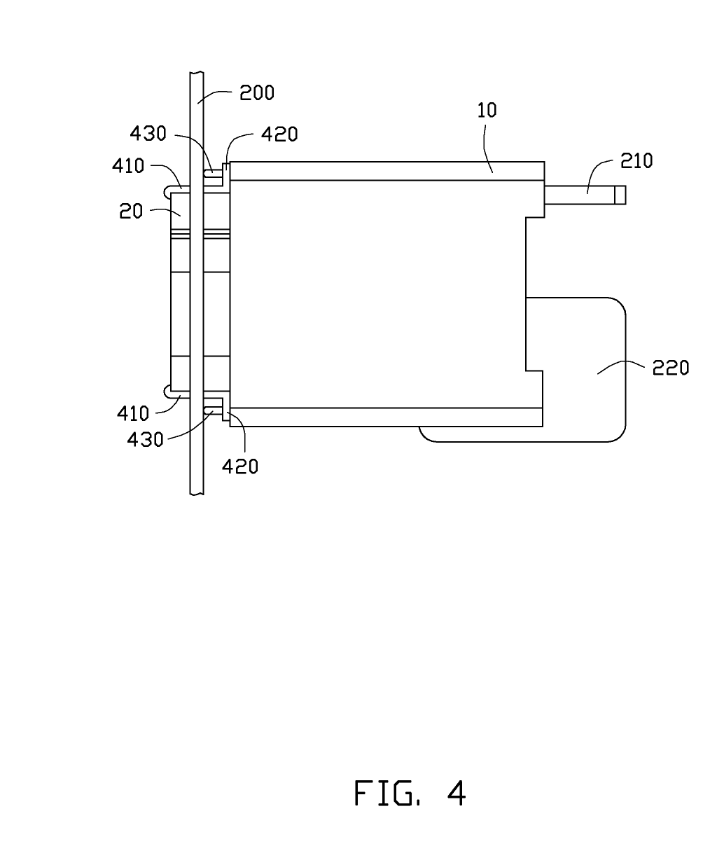

FIGS. 1-2 illustrate an electrical connector assembly 100 of the present disclosure. The electrical connector assembly 100 is mounted to a metallic casing 200 (see FIG. 4) of an electronic device. In the embodiment, the electrical connector assembly 100 is an HDMI connector. The electrical connector assembly 100 includes an insulating body 10, a metallic shell 20, and a number of contacts 30 secured to the insulating body 10. The electrical connector assembly 100 further includes at least one conductive member 40 secured to the metallic shell 20. In the embodiment, there are two conductive members 40, and the conductive members 40 are integrally formed with the metallic shell 20.

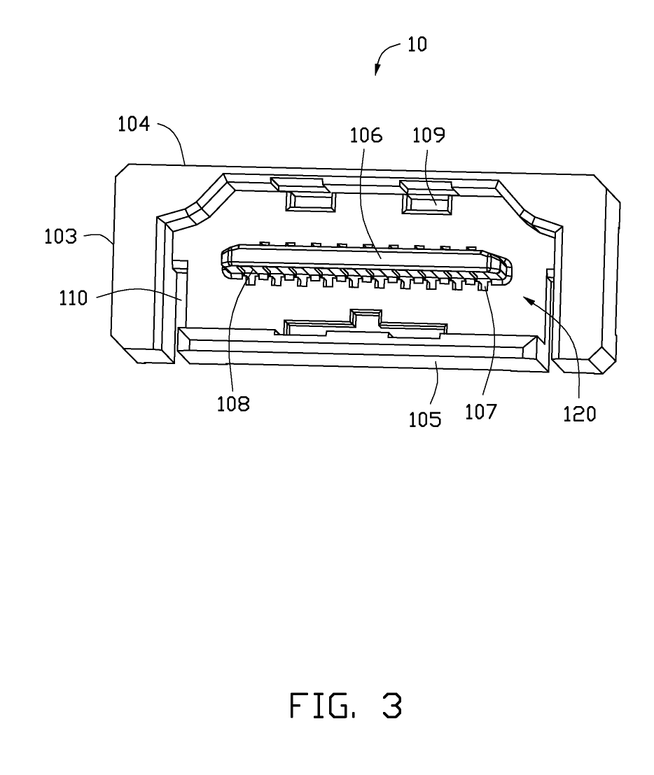

Referring also to FIG. 3, the insulating body 10 is substantially parallelepiped. The insulating body 10 includes a front side 101, a back side 102, two side portions 103, and a top portion 104, all of which cooperatively define a receiving portion 120. Two slits 110 are defined in opposite sides of the back side 102 adjacent to the two side portions 103. The two slits 110 extend to a bottom edge of the back side 102. A bottom portion 105 extends substantially perpendicularly from a bottom edge of the back side 102 into the receiving space 120, such that the bottom portion 105 is located between the two slits 110. The top portion 104 and the bottom portion 105 are substantially parallel to each other and are connected between the side portions 103. A fixing block 106 protrudes from a back wall of the receiving portion 120. The fixing block 106 is substantially parallel to and located between the top portion 104 and the bottom portion 105. The back side 102 defines a number of fixing holes 107. The fixing holes 107 communicate with the receiving portion 120 and are adapted to receive the contacts 30. The fixing holes 107 are arranged in two rows. The two rows of fixing holes 107 are arranged substantially parallel to opposite sides of the fixing portion 106, respectively. The fixing portion 106 further defines a number of recesses 108 corresponding to the number of fixing holes 107 one-to-one. Each recess 108 communicates with a corresponding fixing hole 107. Each recess 108 and the corresponding fixing hole 107 cooperatively secure a contact 30 to the insulating body 10.

The back wall of the receiving portion 120 further defines two apertures 109. The apertures 109 are adjacent to the top portion 104.

Referring again to FIG. 2, the metallic shell 20 is mountably received in the insulating body 10. The metallic shell 20 defines a receiving space 120 for fittingly receiving a plug (not shown) mating with the electrical connector assembly 100. Two first legs 210 and two second legs 220 extend from the metallic shell 20. In the embodiment, the first legs 210 integrally extend from a top surface 201 of the metallic shell 20. The first legs 210 correspond to and are received in the apertures 109. The second legs 220 are arranged at opposite sides of the metallic shell 20, respectively. The second legs 220 are received in the two slits 110 to mount the metallic shell 20 to the insulating body 10. When the metallic shell 20 is mounted to the insulating body 10, the first legs 210 protrude out of the insulating body 10 through the apertures 109, and the second legs 220 protrude out of the insulating body 10 through the slits 110. Thus, the electrical connector assembly 100 is connected to a circuit board by soldering the portions of the first and second legs 210, 220 protruding out of the insulating body 10.

The top surface 201 and the bottom surface 202 of the metallic shell 20 define two substantially rectangular openings 260. An elastic abutting member 270 integrally extends from a sidewall of each opening 260 adjacent to the first legs 210. The elastic abutting member 270 extends substantially parallel to the top surface 201. A distal end of each elastic abutting member 270 extends into the receiving space 250. The elastic abutting members 270 elastically resist the plug received in the receiving space 250 to keep the plug steady in the receiving space 250.

The conducting members 40 integrally protrude from the metallic shell 20. The conducting members 40 are arranged at the top surface 201 and the bottom surface 202 of the metallic shell 20, respectively. Each conducting member includes a connecting portion 410, an abutting portion 420, and an elastic protrusion 430. The connecting portion 410 integrally protrudes from the metallic shell 20. In the embodiment, sides of the top and bottom surface 201, 202 away from the first legs 210 are bent about 180 degrees to form the connecting portions 410. The connecting portions 410 contact the top and bottom surfaces 201, 202. Distal ends of the connecting portions 410 are further bent about 90 degrees to form the abutting portions 420. The abutting portions 420 are substantially perpendicular to the top and bottom surfaces 201, 202. When the metallic shell 20 is mounted to the insulating body 10, a length of the connecting portions 410 is substantially equal to a length of the metallic shell 20 protruding out of the receiving portion 120. Thus, the abutting portions 420 abut the front side 101 after the metallic shell 20 is mounted to the insulating body 10. A number and a location of the conducting members 40 can be changed. For example, in another embodiment, the conducting members 40 are arranged at opposite sidewalls of the metallic shell 20 connected between the top and bottom surfaces 201, 202.

An elastic protrusion 430 protrudes out of each abutting portion 420 along a direction opposite to the first legs 210. In the embodiment, the abutting portions 420 are punched to form the elastic protrusions 430.

Referring to FIG. 4, when the electrical connector assembly 100 is mounted to the metallic casing 200 of the electronic device, the metallic shell 20 extends through a mounting hole (not shown) defined in the housing of the electronic device 200 and protrudes out of the metallic casing 200. Because the elastic protrusions 430 protrude out of the abutting portion 420 in a direction opposite to the first legs 210, the elastic protrusions 430 resist against an inner surface of the metallic casing 200 to maintain a reliable and secure contact between the electrical connector assembly 100 and the metallic casing 200. As a result, the electrical connector assembly 100 is ground to be protected from EMIs.

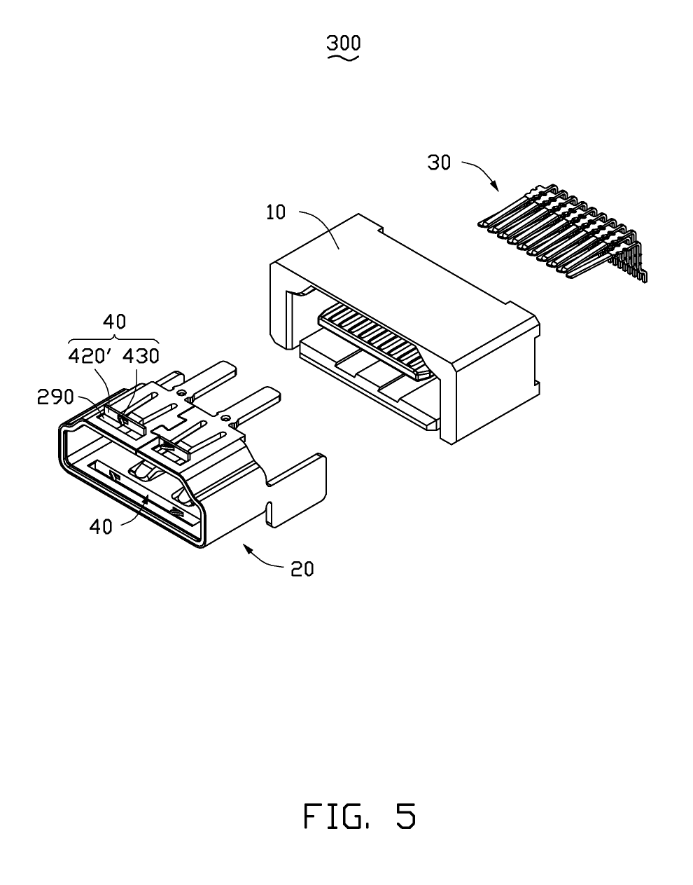

FIG. 5 shows an electrical connector assembly 300 in accordance with a second embodiment. The structure of the electrical connector assembly 300 is similar to the structure of the electrical connector assembly 100. The difference between the electrical connector assembly 200 and the electrical connector assembly 300 is the configuration of the conducting members 40. In the electrical connector assembly 300, both the top surface 201 and the bottom surface 202 of the metallic shell 20 define through holes 290. Abutting portions 420′ of the conducting members 40 integrally extend from sidewalls of the through holes 290 adjacent to the first legs 210. The abutting portions 420′ are substantially perpendicular to the top surface 201 and the bottom surface 202. The elastic protrusions 430 protrude out of each abutting portion 420′ along a direction opposite to the first legs 210. In the second embodiment, the abutting portions 420′ are integrally punched from the metallic shell 20, and the elastic protrusions 430 are integrally punched from the abutting portions 420.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electrical connector assembly mounted to a metallic casing of an electronic device, comprising:
an insulating body;
a metallic shell secured to the insulating body; and
at least one conducting member secured to the metallic shell;
wherein when the electrical connector assembly is mounted to the casing of the electronic device, the at least one conducting member elastically resists against the casing of the electronic device.

2. The electrical connector assembly of claim 1, wherein the insulating body defines a receiving portion, the metallic shell is received in the receiving portion and protrude out of the insulating body, and the at least one conductive member is secured to a part of the metallic shell protruding out of the insulating body.

3. The electrical connector assembly of claim 2, wherein each conducting member includes an abutting portion and at least one elastic protrusion, the abutting portion integrally protrudes from the metallic shell, and the at least one elastic protrusion is secured to and protrudes out of the abutting portion in a direction opposite to the insulating body.

4. The electrical connector assembly of claim 3, wherein each conducting member comprises a connecting portion, the connecting portion bents from an end of the metallic shell away from the insulating body and contact with the metallic shell, the abutting portion bents from a distal end of the connecting portion.

5. The electrical connector assembly of claim 4, wherein the abutting portion abuts the insulating body.

6. The electrical connector assembly of claim 3, wherein the portion of the metallic shell protruding out of the insulating body defines at least one through hole, the abutting portion extends from a sidewall of the through hole adjacent to the insulating body.

7. The electrical connector assembly of claim 4, wherein the abutting portion abuts the insulating body.

8. The electrical connector assembly of claim 1, wherein the at least one conducting member is made of conductive material.

9. The electrical connector assembly of claim 1, wherein the metallic shell comprises two first legs and two second legs, the first legs and the second legs protrude out of the insulating body for allowing the electrical connector assembly being fixed by soldering.

10. The electrical connector assembly of claim 9, wherein a bottom wall of the receiving portion defines two apertures for allowing the first legs extending therethrough.

11. The electrical connector assembly of claim 9, wherein the insulating body further defines two slits, the metallic shell is mounted to the insulating body by the second legs being fitting into the slits.
